(19) United States
(12) Patent Application Publication
(10) Pub. No.: US 2025/0175452 A1
(43) Pub. Date: May 29, 2025

(54) CLOUD NETWORK SYSTEM, CLOUD NETWORK MESSAGE PROCESSING METHOD AND DEVICE

(71) Applicant: BEIJING BAIDU NETCOM SCIENCE TECHNOLOGY CO., LTD., Beijing (CN)

(72) Inventor: Qingzhi ZHOU, Beijing (CN)

(73) Assignee: BEIJING BAIDU NETCOM SCIENCE TECHNOLOGY CO., LTD., Beijing (CN)

(21) Appl. No.: 19/037,663

(22) Filed: Jan. 27, 2025

(30) Foreign Application Priority Data
Mar. 20, 2024 (CN) 202410324242.X

(51) Int. Cl. H04L 9/40

(52) U.S. Cl. CPC H04L 63/0245; H04L 63/0236

(57) ABSTRACT

In the field of cloud networks and network security, which may be applied to intelligent cloud scenarios, a cloud network message processing method includes: obtaining a cloud network message; determining, from at least one type of pre-configured candidate security device, a target type of candidate security device corresponding to the cloud network message; in the case that there are multiple candidate security devices of the target type, determining a target security device from the multiple candidate security devices of the target type based on session information included in the cloud network message, where cloud network messages with same session information correspond to a same target security device; sending the cloud network message to the target security device for security processing, and sending the cloud network message having been security processed by the target security device to a destination.

### CROSS-REFERENCE TO RELATED APPLICATIONS

The present disclosure claims the priority and benefit of Chinese Patent Application No. 202410324242.X, filed on Mar. 20, 2024, entitled “Cloud Network System, Cloud Network Message Processing Method, Apparatus, Device and Medium”. The entire content of the application is incorporated herein by reference.

### TECHNICAL FIELD

The present disclosure relates to the field of artificial intelligence technology, particularly to the fields of cloud networks and network security, which may be applied to intelligent cloud scenarios, and more particularly to a cloud network system, a cloud network message processing method and device.

### BACKGROUND

In the field of network security, users typically use firewalls for network security protection. For example, in traditional Internet Data Center (IDC) environments, users may provide firewalls between public networks and internal networks. Similarly, in cloud environments, cloud vendors also provide their own cloud firewalls to protect data traffic.

As the volume of data traffic requiring security protection increases, the need to address the horizontal scalability of security devices becomes critical.

### SUMMARY

The present disclosure provides a cloud network system, cloud network message processing method and device.

According to one aspect of the present disclosure, a cloud network message processing method is provided, which includes: obtaining a cloud network message, where the cloud network message is sent from a source end to a cloud security device; determining, from at least one type of pre-configured candidate security device, a target type of candidate security device corresponding to the cloud network message; in the case that there are multiple candidate security devices of the target type, determining a target security device from the multiple candidate security devices of the target type based on session information included in the cloud network message, where cloud network messages with same session information correspond to a same target security device; sending the cloud network message to the target security device for security processing, and sending the cloud network message having been security processed by the target security device to a destination end.

According to another aspect of the present disclosure, a cloud network system is provided, which includes: a traffic director and a target security device; the traffic director is configured to obtain a cloud network message, determine, from at least one type of pre-configured candidate security device, a target type of candidate security device corresponding to the cloud network message, in the case that there are multiple candidate security devices of the target type, determine a target security device from the multiple candidate security devices of the target type based on session information included in the cloud network message, send the cloud network message to the target security device for security processing, and send the cloud network message having been security processed by the target security device to a destination end, where the cloud network message is sent from a source end to the cloud security device, and cloud network messages with same session information correspond to a same target security device; the target security device is configured to perform security processing on the cloud network message upon receiving it.

According to another aspect of the present disclosure, an electronic device is provided, which includes: at least one processor; and a memory connected with the at least one processor communicatively; where the memory stores instructions executable by the at least one processor to cause the at least one processor to perform the method according to any one of the above aspects.

It should be understood that the content described in this section is not intended to identify critical or essential features of the embodiments of the present disclosure, nor is it intended to limit the scope of the present disclosure. Other features of the present disclosure will become apparent from the following specification.

### BRIEF DESCRIPTION OF THE DRAWINGS

The drawings are used for better understanding the present solution and do not constitute a limitation of the present disclosure. In the drawings,

FIG. 1 is a schematic diagram of the first embodiment of the present disclosure;

FIG. 2 is a schematic diagram of an application scenario according to an embodiment of the present disclosure;

FIG. 3 is a schematic diagram of the second embodiment of the present disclosure;

FIG. 4 is a schematic diagram of the third embodiment of the present disclosure;

FIG. 5 is a schematic diagram of the fourth embodiment of the present disclosure; and

FIG. 6 is a schematic diagram of an electronic device for implementing the cloud network message processing method according to embodiments of the present disclosure.

### DETAILED DESCRIPTION OF EMBODIMENTS

The following description, combined with the drawings, explains exemplary embodiments of the present disclosure, including various details to aid understanding. It should be understood that these embodiments are merely exemplary. Therefore, those of ordinary skill in the art should recognize that various changes and modifications may be made to the described embodiments without departing from the scope and spirit of the present disclosure. For clarity and brevity, descriptions of well-known functions and structures have been omitted.

In the related art, cloud providers offer their own cloud firewalls for security protection. These cloud firewalls are generally uniform for different users.

However, in some scenarios, users wish to specify their own firewalls for security protection instead of using the cloud firewalls (referred to as built-in firewalls) provided by the current cloud provider.

A firewall specified by a user may be referred to as third-party firewall. The third-party firewall may be provided by an offline vendor or by other cloud provider. For example, if User A is currently using cloud services provided by a first cloud provider, User A may choose to use a cloud firewall provided by a second cloud provider as a third-party firewall.

Regardless of the type of firewall used—whether it is a built-in firewall or a third-party firewall—as the volume of data traffic requiring security protection increases, the issue of horizontal scalability of firewalls needs to be addressed. Horizontal scalability refers to increasing the number of firewalls used by users.

To support the horizontal scalability of third-party security devices on the cloud, the present disclosure provides the following embodiments.

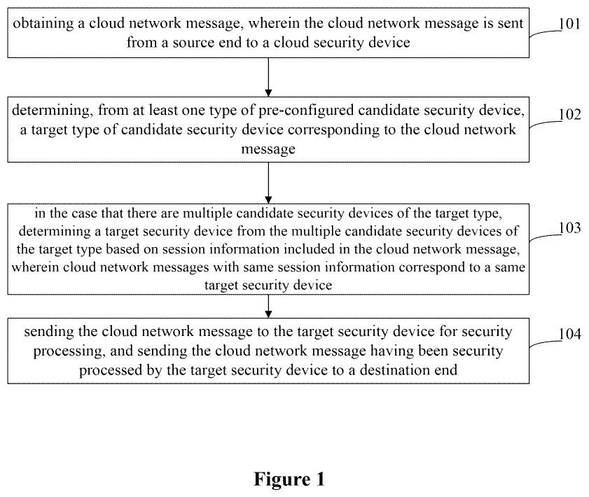

FIG. 1 is a schematic diagram of a first embodiment of the present disclosure. This embodiment provides a cloud network message processing method. As shown in FIG. 1, the method includes:
101: obtaining a cloud network message, where the cloud network message is sent from a source end to a cloud security device;
102: determining, from at least one type of pre-configured candidate security device, a target type of candidate security device corresponding to the cloud network message;
103: in the case that there are multiple candidate security devices of the target type, determining a target security device from the multiple candidate security devices of the target type based on session information included in the cloud network message, where cloud network messages with same session information correspond to a same target security device; and
104: sending the cloud network message to the target security device for security processing, and send the cloud network message having been security processed by the target security device to a destination end.

The entity executing this embodiment may be referred to as a traffic director. The traffic director may be provided inside the cloud security device provided by the current cloud provider, or it may be provided outside the cloud security device.

Specifically, if the traffic director is provided inside the cloud security device, the cloud security device includes the traffic director and a built-in security device. The traffic director is primarily responsible for forwarding cloud network messages, while the built-in security device is responsible for performing security processing on the cloud network messages upon receiving them.

If the traffic director is provided outside the cloud security device, the traffic director may be pre-connected to the cloud security device. After receiving the cloud network message sent by the source end, the cloud security device sends the message to the traffic director. The traffic director determines a target security device and then forwards the cloud network message to the target security device. After the target security device performs security processing, the traffic director forwards the processed cloud network message to a destination end. In this case, the cloud security device includes a built-in security device, which is responsible for performing security processing on the cloud network messages upon receiving them.

The security device refer to a device that perform security processing on network messages. Examples include a firewall, a intrusion detection system, a data encryption device or a security gateway, etc.

Taking a firewall as an example, the cloud security device specifically refers to a cloud firewall, the built-in security device refers to a built-in firewall, and the third-party security device refers to a third-party firewall.

The source end refers to a device that sends the cloud network message.

The destination end refers to a device that receives the cloud network message.

Assuming the message is transmitted from the public network to the cloud network, the source end refers to the public network device, and the destination end refers to the cloud network device. Further, the cloud security device typically interacts with gateway devices. Based on the above example, the source end is specifically the public network gateway, and the destination end is the cloud network gateway.

The candidate security device refers to a security device which can be selected by a user.

In the related art, in cloud environments, a cloud provider only offers a cloud security device, which is shared by different users. That is, for different users, the cloud security device is the same.

However, in some scenarios, users may wish to specify their own security devices.

The third-party security device refers to a security device other than the cloud security device corresponding to the cloud service currently used by the user. The third-party security device may be provided by an offline vendor, or the third-party security device may be provided by another cloud provider. For example, if User A is currently using cloud services provided by a first cloud provider, User A may choose to use a cloud firewall provided by a second cloud provider as a third-party security device. Specifically, a user may purchase a mirror of a third-party security device and deploy a third-party security device on one or more cloud hosts based on the mirror.

In a cloud environment, at least one type of candidate security device may be pre-configured. For example, this may include a cloud security device deployed by the current cloud provider and/or a third-party security device deployed by a user.

The target type refers to a type of security device that the user wishes to use. For example, the target type may be a built-in security device inside the cloud security device (referred to as the cloud security device), or the target type may be a third-party security device external to the cloud security device.

Although different users share a same cloud security device, in different scenarios, different users may wish to use different types of candidate security devices. For example, User A may prefer to use the cloud security device (built-in security device), while User B may prefer to use a third-party security device.

Specifically, a user may pre-configure the desired type of target security device on the traffic director. The configuration information records the type of target security device that the user wishes to use. For example, the configuration information may include: User A corresponds to Type 1 (e.g., Type 1 refers to the cloud security device), and User B corresponds to Type 2 (e.g., Type 2 refers to a third-party security device). The cloud network message may carry user identification information. After receiving the cloud network message, the traffic director may determine the type of target security device based on the user identification information carried in the message and the pre-configured mapping between user identification information and security device types. For example, based on the above example, if the cloud network message carries User A's identification information, the type of target security device is determined to be the cloud security device. If the cloud network message carries User B's identification information, the type of target security device is determined to be a third-party security device.

Furthermore, each type of candidate security device may be one or more. For example, there may be one or more built-in security devices inside the cloud security device, and there may be one or more third-party security devices.

The target security device refers to the security device that processes the cloud network message.

If only one candidate security device of the target type is determined, the one candidate security device is taken as the target security device.

To handle more traffic, multiple candidate security devices of the target type need to be deployed. For example, if the target type is a third-party security device, multiple third-party security devices may be deployed.

In the case that there are multiple candidate security devices of the target type, the issue of how to select one from these multiple candidate security devices as the target security device needs to be addressed.

For example, if the target type is a third-party security device, assuming the security device is a firewall, since third-party firewalls are typically deployed inside a Virtual Private Cloud (VPC), they can also be referred to as virtual firewalls. Suppose the candidate security devices of the target type include: a first virtual firewall, a second virtual firewall, and a third virtual firewall. It is to be determined which one of the three virtual firewalls should be used to perform security processing on the cloud network message.

In this embodiment, based on the session information in the cloud network message, the target security device is determined from multiple candidate security devices of the target type. Moreover, cloud network messages with same session information correspond to a same target security device.

Session information is used to identify a session. Each session corresponds to a Transmission Control Protocol (TCP) connection or a User Datagram Protocol (UDP) connection.

The session information may be session identification information, which uniquely identifies a session.

Alternatively, the session information may include: the source Internet Protocol (IP) address and the destination IP address.

For two cloud network messages, if their source IP addresses and destination IP addresses are the same, their session information is the same, and these two cloud network messages are sent to the same target security device. The source IP address and destination IP address mentioned above being the same refer to the same in an order-independent manner. For example, if the source IP address of the first message is IP1 and the destination IP address is IP2, while the source IP address of the second message is IP2 and the destination IP address is IP1, since the source and destination IP addresses of both messages are IP1 and IP2, the session information of these two messages is the same.

Taking the session information as including the source IP address and destination IP address as an example, the target security device may be determined from multiple candidate security devices of the target type based on the source IP address and destination IP address included in the cloud network message. For instance, an order-independent hash computation may be performed on the source IP address and destination IP address to obtain a hash value. Then, based on the hash value and the number of candidate security devices of the target type, the target security device may be determined.

After the traffic director determines the target security device, the cloud network message is sent to the target security device.

The cloud provider can pre-establish a traffic routing path between the traffic director and the built-in security device. This way, if a user wishes to use the built-in security device, the cloud network message can be sent to the built-in security device based on the traffic routing path provided by the cloud provider. If the user wishes to use a third-party security device, after deploying the third-party security device, the user can also configure a traffic routing path between the traffic director and the third-party security device. This allows the cloud network message to be sent to the third-party security device through the user-configured traffic routing path.

Since the traffic routing path is pre-configured, after receiving the cloud network message, the traffic director may forward the message to the target security device based on the pre-configured traffic routing path corresponding to the target security device. In contrast, if forwarding is based on routing policies, after receiving the cloud network message, routing resolution and identification processes need to be performed to determine the routing path before forwarding the message. In this embodiment, by using the pre-configured traffic routing path for forwarding, the need for routing resolution and identification is eliminated, thereby improving the efficiency of message forwarding and, consequently, the processing efficiency of cloud network messages.

Specifically, on the traffic director, different candidate security devices may be configured to correspond to different output ports. The cloud network message may be forwarded through the output port corresponding to the target security device. For example, a port corresponding to the built-in security device is a first output port of the traffic director, and a port corresponding to the third-party security device is a second output port of the traffic director. The first output port is different from the second output port. If the target security device is the built-in security device, the cloud network message is forwarded to the built-in security device through the first output port. If the target security device is the third-party security device, the cloud network message is forwarded to the third-party security device through the second output port.

After receiving the cloud network message, the target security device performs security processing on the message based on pre-configured security rules and returns the processed message to the traffic director. The traffic director then sends the processed message to the destination end.

In this embodiment, based on the session information included in the cloud network message, the target security device is determined from multiple candidate security devices of the target type. The cloud network message is then processed by the target security device. Since there may be multiple candidate security devices of the target type, this approach enables horizontal scaling of security devices on the cloud. Additionally, cloud network messages with same session information correspond to a same target security device, ensuring that all messages of the same session are sent to the same target security device for processing, which improves processing accuracy and enhances security capabilities.

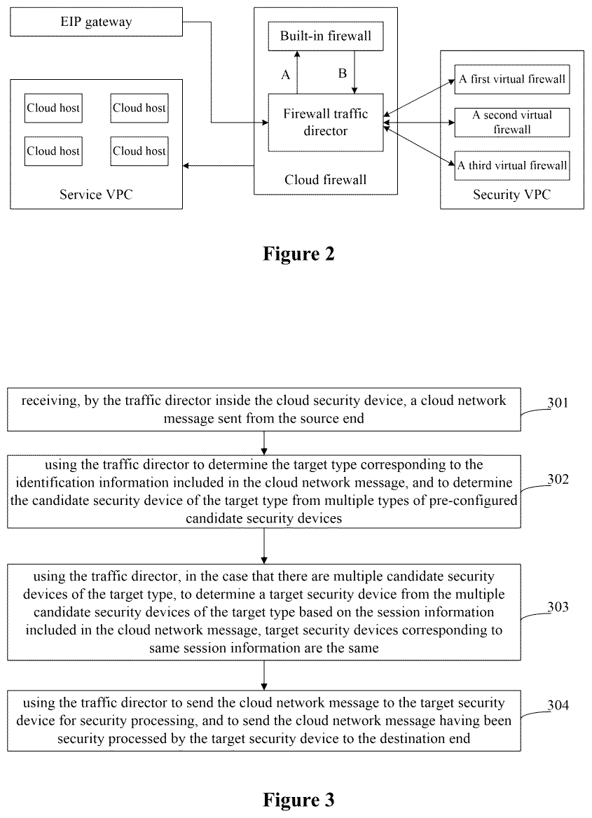

FIG. 2 is a schematic diagram of an application scenario according to an embodiment of the present disclosure. In this embodiment, firewalls are taken as an example of the security devices. The cloud provider may deploy one or more cloud firewalls (CFW) among the public network (Elastic IP, EIP), cloud smart network (Cloud Smart Network, CSN), and dedicated connection (Dedicated Connection, DC) networks to perform security access control on traffic from the internet, dedicated connections, and virtual private clouds (VPCs).

The cloud firewall provided by the cloud provider is shared by all users. After enabling the cloud firewall service, users can route messages to the cloud firewall for security processing based on the default routing policy. However, in some scenarios, users may wish to use their own third-party firewalls for security protection.

To support third-party firewalls, the routing policy on the gateway may be modified. Taking communication between the CSN (Cloud Smart Network) and the user's IDC (Internet Data Center) via the DC (Dedicated Connection) network as an example, the routing policy on the CSN gateway (CSN-GW) may be modified to route messages sent by the CSN to the third-party firewall. The third-party firewall processes the messages and sends the processed messages to the DC gateway, which then forwards them to the IDC. Correspondingly, the routing policy on the DC gateway also needs to be modified so that messages sent by the IDC to the DC gateway can be forwarded to the third-party firewall, which processes them and sends the processed messages back to the CSN.

Although modifying the routing policy in this manner can support third-party firewalls, this approach is complex to implement because it requires changing the routing policies on the gateways of various networks.

To reduce implementation complexity, in this embodiment, there is no need to modify the routing policies on the gateways. After enabling the cloud firewall service, users can route messages to the cloud firewall based on the default routing policy. The cloud firewall then sends the messages to the built-in firewall or the third-party firewall for security processing based on the configuration information pre-set by the user.

Taking communication between the public network (EIP) and the VPC (Virtual Private Cloud) as an example, as shown in FIG. 2, the cloud firewall includes a firewall traffic director and a built-in firewall. The firewall traffic director is responsible for receiving cloud network messages, determining the target firewall, forwarding the cloud network messages to the target firewall for security processing, and sending the cloud network messages, after security processing by the target firewall, to the destination end. The built-in firewall is responsible for performing security processing on the cloud network messages forwarded to itself and returning the processed cloud network messages to the firewall traffic director. The third-party firewall is deployed by the user and can be deployed on one or more cloud hosts. The VPC that processes the cloud network messages may be referred to as the business VPC, and the VPC that deploys the third-party firewall may be referred to as the security VPC.

Taking the example of sending cloud network messages from the public network to the VPC, the source end is an EIP gateway. The EIP gateway sends the cloud network messages to the cloud firewall based on the default routing policy. The firewall traffic director inside the cloud firewall determines the target firewall based on the preset configuration information. For example, the cloud network message contains user identification information, the firewall traffic director has pre-configured a mapping between user identification information and firewall types (built-in firewall or third-party firewall), the target type will be determined based on the user identification information contained in the cloud network message and this mapping. If there is only one candidate firewall of the target type, the one candidate firewall will be taken as the target firewall.

Assuming the target firewall is the built-in firewall and there is only one built-in firewall, the firewall traffic director sends the cloud network message to the built-in firewall via path A. The built-in firewall performs security processing on the cloud network message and returns it to the firewall traffic director via path B.

The third-party firewall may also be referred to as a virtual firewall. To provide security protection for more data traffic, the user can pre-deploy multiple virtual firewalls. As shown in FIG. 2, suppose the multiple virtual firewalls include a first virtual firewall, a second virtual firewall, and a third virtual firewall.

If the target type determined based on the cloud network message is the third-party firewall (virtual firewall), one of these three virtual firewalls needs to be selected as the target firewall. For example, if the first virtual firewall is the target firewall, the cloud network message is sent to the first virtual firewall, which performs security processing on the message.

In the above example, the target type of candidate security device is the third-party security device. However, there may be multiple built-in security devices, and when there are multiple built-in security devices of the target type, the processing is similar to that of the multiple virtual firewalls.

After the firewall traffic director determines the target firewall, it sends the cloud network message to the target firewall for security processing and receives the cloud network message having been security processed by the target firewall. The processed cloud network message is then sent to the destination end, such as a cloud host inside the service VPC.

Based on the above application scenario, the present disclosure also provides the following embodiments.

FIG. 3 is a schematic diagram of a second embodiment of the present disclosure, which provides a cloud network message processing method. This embodiment takes the example where the cloud security device includes a built-in security device and a traffic director. The method includes:
301: using the traffic director inside the cloud security device to receive a cloud network message sent from the source end.
302: using the traffic director to determine the target type corresponding to the identification information included in the cloud network message, and to determine the candidate security device of the target type from multiple types of pre-configured candidate security devices.
303: using the traffic director, in the case that there are multiple candidate security devices of the target type, to determine a target security device from the multiple candidate security devices of the target type based on the session information included in the cloud network message, target security devices corresponding to same session information are the same.
304: using the traffic director to send the cloud network message to the target security device for security processing, and to send the cloud network message having been security processed by the target security device to the destination end.

In this embodiment, by setting a traffic director inside the cloud security device, the cloud network messages received by the cloud security device from the source end are forwarded to the target security device. This eliminates the need for the source end to modify routing policies or perform other operations. The cloud network messages are forwarded to the target security device of the user's desired type seamlessly, thereby supporting various types of target security devices in the cloud environment in a simple and efficient manner.

The cloud network message may contain identification information.

Specifically, the identification information may be user identification information. In this case, a mapping between user identification information and security device types may be pre-configured. Based on this mapping, the target type corresponding to the identification information included in the cloud network message is determined. Alternatively, the identification information may be type identification information. In this case, the type indicated by the type identification information is directly taken as the target type.

Then, the target security device is determined from the candidate security devices of the target type.

In this embodiment, the target type is determined based on the identification information included in the cloud network message, and the target security device is determined from the candidate security devices corresponding to the target type. This allows for a simple and accurate determination of the target security device.

If there is only one candidate security device of the target type, the one candidate security device is taken as the target security device. Alternatively, if there are multiple candidate security devices of the target type, one candidate security device is determined from the multiple candidate security devices as the target security device.

For example, if the determined target type is a third-party security device and there is only one third-party security device, that third-party security device is taken as the target security device. If the determined target type is a third-party security device but there are multiple third-party security devices, one can be determined from the multiple third-party security devices as the target security device.

When there are multiple candidate security devices of the target type, the target security device may be determined based on the session information in the cloud network message.

Specifically, the session information includes a source IP address and a destination IP address.

The target security device may be determined from the multiple candidate security devices of the target type based on the session information included in the cloud network message by performing the following steps:
perform combination processing on the source IP address and the destination IP address to obtain a combined IP address;
perform an order-independent hash computation on the combined IP address to obtain a hash value;
perform a modulo operation based on the hash value and the number of candidate security devices of the target type to obtain a remainder; and
take a candidate security device of the target type corresponding to the remainder as the target security device.

For example, for a specific cloud network message, if the source IP address and destination IP address are represented by IP1 and IP2, respectively, the combined IP address is represented as (IP1, IP2). If the two binary values are 110 and 101, the combined binary value is 110101. The combination principle for IP addresses is the same.

After obtaining the combined IP address, an order-independent hash computation is performed on the combined IP address. A hash computation refers to converting an input of arbitrary length into an output of fixed length.

An order-independent hash computation means that hash (IP1, IP2)=hash (IP2, IP1).

Suppose the hash value is represented by M and the number of candidate security devices of the target type is represented by N. The modulo operation refers to calculating the remainder of M relative to N. For example, if N=3, the remainder will be 0, 1, or 2.

Additionally, a mapping between the remainder and the candidate security devices can be pre-configured, and the target security device is determined based on the calculated remainder and this mapping. For example, remainder 0 corresponds to a first virtual firewall, remainder 1 corresponds to a second virtual firewall, and remainder 2 corresponds to a third virtual firewall. If the calculated remainder is 0, the target firewall is the first virtual firewall.

In this embodiment, performing an order-independent hash computation on the combined IP address and determining the target security device based on the hash value and the number of candidate security devices of the target type can ensure that cloud network messages with the same session information are sent to the same target security device in a simple and efficient manner. This improves the accuracy of security processing for cloud network messages and enhances the security protection capabilities of security devices in the cloud environment.

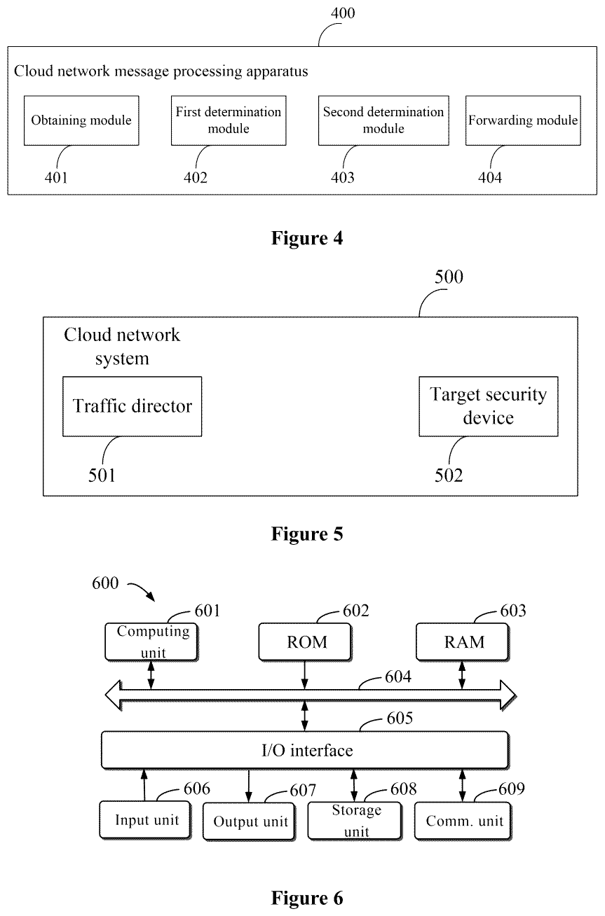

FIG. 4 is a schematic diagram of a third embodiment of the present disclosure, which provides a cloud network message processing apparatus. Apparatus 400 includes: an obtaining module 401, a first determination module 402, a second determination module 403 and a forwarding module 404.

The obtaining module 401 is configured to obtain a cloud network message, where the cloud network message is sent from a source end to a cloud security device. The first determination module 402 is configured to determine, from at least one type of pre-configured candidate security device, a target type of candidate security device corresponding to the cloud network message. The second determination module 403 is configured to, in the case that there are multiple candidate security devices of the target type, determine a target security device from the multiple candidate security devices of the target type based on the session information included in the cloud network message. The cloud network messages with same session information correspond to a same target security device. The forwarding module 404 is configured to send the cloud network message to the target security device for security processing, and send the cloud network message having been security processed by the target security device to a destination end.

In this embodiment, based on the session information included in the cloud network message, the target security device is determined from multiple candidate security devices of the target type. The cloud network message is then processed by the target security device. Since there may be multiple candidate security devices of the target type, this approach enables horizontal scaling of security devices on the cloud. Additionally, cloud network messages with same session information correspond to the same target security device, ensuring that all messages of the same session are sent to the same target security device for processing, which improves processing accuracy and enhances security capabilities.

In some embodiments, the session information includes a source IP address and a destination IP address. The second determination module 403 is further configured to: perform combination processing on the source IP address and the destination IP address to obtain a combined IP address; perform an order-independent hash computation on the combined IP address to obtain a hash value; perform a modulo operation based on the hash value and the number of candidate security devices of the target type to obtain a remainder; and take a candidate security device of the target type corresponding to the remainder as the target security device.

In this embodiment, performing an order-independent hash computation on the combined IP address and determining the target security device based on the hash value and the number of candidate security devices of the target type can ensure that cloud network messages with the same session information are sent to the same target security device in a simple and efficient manner. This improves the accuracy of security processing for cloud network messages and enhances the security protection capabilities of security devices in the cloud environment.

In some embodiments, the at least one type of candidate security device includes multiple types of candidate security devices.

The first determination module 402 is further configured to:
determine a target type corresponding to the identification information included in the cloud network message;
determine the candidate security device of the target type from pre-configured multiple types of candidate security devices.

In this embodiment, the target type is determined based on the identification information included in the cloud network message, and the candidate security device corresponding to the target type is obtained as the target security device. This allows for a simple and accurate determination of the target security device.

In some embodiments, the multiple types of candidate security devices include a built-in security device inside the cloud security device and a third-party security device external to the cloud security device.

The cloud security device internally further includes a traffic director. The obtaining module 401 is further configured to:
receive, by the traffic director, the cloud network message sent from the source end.

In this embodiment, by setting a traffic director inside the cloud security device, the cloud network messages received by the cloud security device from the source end can be forwarded to the target security device. This eliminates the need for the source end to modify routing policies or perform other operations. The cloud network messages can be forwarded to the target security device of the user's desired type seamlessly, thereby supporting various types of target security devices in the cloud environment in a simple and efficient manner.

FIG. 5 is a schematic diagram of a fourth embodiment of the present disclosure, which provides a cloud network system. The system 500 includes: a traffic director 501 and a target security device 502.

The traffic director 501 is configured to obtain a cloud network message; determine, from at least one type of pre-configured candidate security device, a target type of candidate security device corresponding to the cloud network message; in the case that there are multiple candidate security devices of the target type, determine a target security device from the multiple candidate security devices of the target type based on the session information included in the cloud network message; send the cloud network message to the target security device for security processing, and send the cloud network message having been security processed by the target security device to a destination end. The cloud network message is sent from a source end to the cloud security device, and cloud network messages with same session information correspond to a same target security device. The target security device 502 is configured to perform security processing on the cloud network message upon receiving it.

In this embodiment, based on the session information included in the cloud network message, the target security device is determined from multiple candidate security devices of the target type. The cloud network message is then processed by the target security device. Since there may be multiple candidate security devices of the target type, this approach enables horizontal scaling of security devices on the cloud. Additionally, cloud network messages with the same session information correspond to the same target security device, ensuring that all messages of the same session are sent to the same target security device for processing, which improves processing accuracy and enhances security capabilities.

In some embodiments, the session information includes a source IP address and a destination IP address.

The traffic director 501 is further configured to:
perform combination processing on the source IP address and the destination IP address to obtain a combined IP address;
perform an order-independent hash computation on the combined IP address to obtain a hash value;
perform a modulo operation based on the hash value and the number of candidate security devices of the target type to obtain a remainder; and
take a candidate security device of the target type corresponding to the remainder as the target security device.

In this embodiment, performing an order-independent hash computation on the combined IP address and determining the target security device based on the hash value and the number of candidate security devices of the target type may ensure that cloud network messages with the same session information are sent to the same target security device in a simple and efficient manner. This improves the accuracy of security processing for cloud network messages and enhances the security protection capabilities of security devices in the cloud environment.

In some embodiments, the at least one type of candidate security device includes multiple types of candidate security device.

The traffic director 501 is further configured to:
determine a target type corresponding to the identification information included in the cloud network message;
determine the candidate security device of the target type from pre-configured multiple types of candidate security devices.

In this embodiment, the target type is determined based on the identification information included in the cloud network message, and the target security device is obtained from the candidate security device corresponding to the target type. This allows for a simple and accurate determination of the target security device.

In some embodiments, the multiple types of candidate security devices include a built-in security device inside the cloud security device and a third-party security device external to the cloud security device.

The traffic director is located inside the cloud security device and is further configured to:
receive the cloud network message sent from the source end.

In this embodiment, by setting a traffic director inside the cloud security device, the cloud network messages received by the cloud security device from the source end can be forwarded to the target security device. This eliminates the need for the source end to modify routing policies or perform other operations. The cloud network messages can be forwarded to the target security device of the user's desired type seamlessly, thereby supporting various types of target security devices in the cloud environment in a simple and efficient manner.

It should be understood that, in the embodiments of the present disclosure, the same or similar contents in different embodiments may be mutually referenced.

The terms “first,” “second,” etc., are used for distinction purposes only and do not indicate any order, importance, or priority.

It is to be noted that, unless otherwise specified, the temporal relationship between the steps in the method procedure is not limited although the steps are described in a specific order.

As used in the description herein and throughout the claims that follow, “a”, “an”, and “the” includes plural references unless the context clearly dictates otherwise.

The technical solutions of the present disclosure comply with relevant laws and regulations and do not violate public order and good customs when collecting, storing, using, processing, transmitting, providing, and disclosing user personal information.

According to an embodiment of the present disclosure, an electronic device, a computer-readable storage medium, and a computer program product are also provided.

FIG. 6 shows a schematic block diagram of an example electronic device 600 that may be used to implement the embodiments of the present disclosure. The electronic device 600 is intended to represent various forms of digital computers, such as laptops, desktop computers, workstations, servers, blade servers, mainframes, and other suitable computing devices. The electronic device may also represent various forms of mobile devices, such as personal digital assistants, cellular phones, smartphones, wearable devices, and other similar computing devices. The components, their connections, relationships, and functionalities shown in this document are merely examples and are not intended to limit the implementation of the present disclosure as described and/or claimed herein.

As shown in FIG. 6, the electronic device 600 includes a computing unit 601, which may perform various appropriate actions and processing based on computer programs stored in a Read-Only Memory (ROM) 602 or loaded from a storage unit 608 into a Random Access Memory (RAM) 603. Various programs and data required for the operation of the electronic device 600 are also stored in the RAM 603. The computing unit 601, ROM 602, and RAM 603 are interconnected via a bus 604. An Input/Output (I/O) interface 605 is also connected to the bus 604.

Multiple components in the device 600 are connected to the I/O interface 605, and include: an input unit 606, such as a keyboard, a mouse, or the like; an output unit 607, such as various types of displays, speakers, or the like; the storage unit 608, such as a magnetic disk, an optical disk, or the like; and a communication unit 609, such as a network card, a modem, a wireless communication transceiver, or the like. The communication unit 609 allows the device 600 to exchange information/data with other devices through a computer network, such as the Internet, and/or various telecommunication networks.

The computing unit 601 may be a variety of general and/or special purpose processing components with processing and computing capabilities. Some examples of the computing unit 601 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 601 performs the methods and processing operations described above, such as the method according to the present disclosure. For example, in some embodiments, the method according to the present disclosure may be implemented as a computer software program tangibly contained in a machine readable medium, such as the storage unit 608. In some embodiments, part or all of the computer program may be loaded and/or installed into the device 600 via the ROM 602 and/or the communication unit 609. When the computer program is loaded into the RAM 603 and executed by the computing unit 601, one or more steps of the method according to the present disclosure may be performed. Alternatively, in other embodiments, the computing unit 601 may be configured to perform the method according to the present disclosure by any other suitable means (for example, by means of firmware).

Various implementations of the systems and technologies described herein above may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input apparatus, and at least one output apparatus.

Program codes for implementing the method according to the present disclosure may be written in any combination of one or more programming languages. These program codes may be provided to a processor or a controller of a general purpose computer, a special purpose computer, or other programmable data processing apparatuses, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server or a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A cloud network message processing method, comprising:
obtaining a cloud network message, wherein the cloud network message is sent from a source end to a cloud security device;
determining, from at least one type of pre-configured candidate security device, a target type of candidate security device corresponding to the cloud network message;
in the case that there are multiple candidate security devices of the target type, determining a target security device from the multiple candidate security devices of the target type based on session information included in the cloud network message, wherein cloud network messages with same session information correspond to a same target security device; and
sending the cloud network message to the target security device for security processing, and sending the cloud network message having been security processed by the target security device to a destination end.

2. The method according to claim 1, wherein:
the session information comprises a source IP address and a destination IP address; and
wherein determining the target security device based on the session information included in the cloud network message comprises:
performing combination processing on the source IP address and the destination IP address to obtain a combined IP address;
performing an order-independent hash computation on the combined IP address to obtain a hash value;
performing a modulo operation based on the hash value and the number of candidate security devices of the target type to obtain a remainder; and
taking a candidate security device of the target type corresponding to the remainder as the target security device.

3. The method according to claim 1, wherein:
the at least one type of candidate security device comprises multiple types of candidate security devices; and
wherein determining, from at least one type of pre-configured candidate security device, the target type of candidate security device corresponding to the cloud network message comprises:
determining a target type corresponding to identification information included in the cloud network message; and
determining the candidate security devices of the target type from pre-configured multiple types of candidate security devices.

4. The method according to claim 3, wherein:
the multiple types of candidate security devices comprise: a built-in security device inside the cloud security device and a third-party security device external to the cloud security device;
wherein the cloud security device internally further comprises: a traffic director; and
wherein obtaining the cloud network message comprises:
receiving, by the traffic director, the cloud network message sent from the source end.

5. The method according to claim 1, wherein the cloud network message is sent to the target security device through a traffic routing path pre-established corresponding to the target security device.

6. A cloud network system, comprising:
a traffic director and a target security device;
wherein the traffic director is configured to obtain a cloud network message, determine, from at least one type of pre-configured candidate security device, a target type of candidate security device corresponding to the cloud network message, in the case that there are multiple candidate security devices of the target type, determine a target security device from the multiple candidate security devices of the target type based on session information included in the cloud network message, send the cloud network message to the target security device for security processing, and send the cloud network message having been security processed by the target security device to a destination end, wherein the cloud network message is sent from a source end to the cloud security device, and cloud network messages with same session information correspond to a same target security device; and
the target security device is configured to perform security processing on the cloud network message upon receiving it.

7. The system according to claim 6, wherein:
the session information comprises a source IP address and a destination IP address; and
wherein the traffic director is further configured to:
perform combination processing on the source IP address and the destination IP address to obtain a combined IP address;
perform an order-independent hash computation on the combined IP address to obtain a hash value;
perform a modulo operation based on the hash value and the number of candidate security devices of the target type to obtain a remainder; and
take a candidate security device of the target type corresponding to the remainder as the target security device.

8. The system according to claim 6, wherein:
the at least one type of candidate security device comprises multiple types of candidate security devices; and
wherein the traffic director is further configured to:
determine a target type corresponding to identification information included in the cloud network message; and
determine the candidate security devices of the target type from pre-configured multiple types of candidate security devices.

9. The system according to claim 8, wherein:
the multiple types of candidate security devices comprise: a built-in security device inside the cloud security device and a third-party security device external to the cloud security device;
the traffic director is located inside the cloud security device;
wherein the traffic director is further configured to:
receive the cloud network message sent from the source end.

10. The system according to claim 9, wherein the built-in security device is a built-in firewall, and the third-party security device is a virtual firewall pre-deployed by a user sending the cloud network message.

11. An electronic device used as a cloud security device, comprising:
at least one processor; and
a memory connected with the at least one processor communicatively;
wherein the memory stores instructions executable by the at least one processor to cause the at least one processor to perform a cloud network message processing method, comprising:
obtaining a cloud network message, wherein the cloud network message is sent from a source end to the cloud security device;
determining, from at least one type of pre-configured candidate security device, a target type of candidate security device corresponding to the cloud network message;
in the case that there are multiple candidate security devices of the target type, determining a target security device from the multiple candidate security devices of the target type based on session information included in the cloud network message, wherein cloud network messages with same session information correspond to a same target security device; and
sending the cloud network message to the target security device for security processing, and sending the cloud network message having been security processed by the target security device to a destination end.

12. The electronic device according to claim 11, wherein:
the session information comprises a source IP address and a destination IP address; and
wherein determining the target security device based on the session information included in the cloud network message comprises:
performing combination processing on the source IP address and the destination IP address to obtain a combined IP address;
performing an order-independent hash computation on the combined IP address to obtain a hash value;
performing a modulo operation based on the hash value and the number of candidate security devices of the target type to obtain a remainder; and
taking a candidate security device of the target type corresponding to the remainder as the target security device.

13. The electronic device according to claim 11, wherein:
the at least one type of candidate security device comprises multiple types of candidate security devices; and
wherein determining, from at least one type of pre-configured candidate security device, the target type of candidate security device corresponding to the cloud network message comprises:
determining a target type corresponding to identification information included in the cloud network message; and
determining the candidate security devices of the target type from pre-configured multiple types of candidate security devices.

14. The electronic device according to claim 13, wherein:
the multiple types of candidate security devices comprise: a built-in security device inside the cloud security device and a third-party security device external to the cloud security device;
wherein the cloud security device internally further comprises: a traffic director, and the cloud network message is received by the traffic director.

15. The electronic device according to claim 11, wherein the cloud network message is sent to the target security device through a traffic routing path pre-established corresponding to the target security device.
